(19) United States
(12) Patent Application Publication
(10) Pub. No.: US 2022/0129603 A1
(43) Pub. Date: Apr. 28, 2022

(54) MOTOR WINDING INSULATION DIAGNOSIS AND PROGNOSIS USING RESISTANCE SIMULATION METHOD

(71) Applicant: University of south Carolina, Columbia, SC (US)

(72) Inventors: Enhui Liu, Columbia, SC (US); Bin Zhang, Irmo, SC (US)

(73) Assignee: University of South Carolina, Columbia, SC (US)

(21) Appl. No.: 17/510,473

(22) Filed: Oct. 26, 2021

Related U.S. Application Data
(60) Provisional application No. 63/105,944, filed on Oct. 27, 2020.

(51) Int. Cl. G06F 30/20

(52) U.S. Cl. CPC G06F 30/20; G06F 2111/10

(57) ABSTRACT

Described herein is a fast and high-fidelity fault model of PMSM which can describe the dynamic performance of motors accurately, using an equivalent resistance simulation method to simulate the number of short turns of stator winding with the help of an established motor model and the given relationship between the value of the resistance and the number of short turns of stator winding, fault diagnosis and prognosis of the experimental motor is conducted based on the Hilbert transform method under a Riemann/Lebesgue sampling framework, which results in low computation and small uncertainty accumulation.

### TECHNICAL FIELD

The subject matter disclosed herein is generally directed to a fast and high-fidelity fault model of a Permanent Magnet Synchronous Motor (PMSM), which can describe the dynamic performance of motors accurately, using an equivalent resistance simulation method to simulate the number of short turns of stator winding with the help of an established motor model and the given relationship between the value of the resistance and the number of short turns of stator winding, fault diagnosis and prognosis of the experimental motor is conducted based on the Hilbert transform method under a Riemann/Lebesgue sampling framework, which results in low computation and small uncertainty accumulation.

### BACKGROUND

Traditional diagnosis and prognosis methods focus mainly on sensor, mechanical, and electrical faults. For electrical faults, they do not fully describe the transient dynamic performance of the winding insulation faults, which often leads to misdecision of motor driving systems. Motors are critical components of industrial systems, electrical cars, and unmanned vehicles, etc. Hundreds of companies around the world are conducting related work on motor function. For aerospace and civil aircraft, fault diagnosis and prognosis of motors will significantly reduce operation and maintenance costs. Meanwhile, it will avoid catastrophic events that lead to system damage or loss of human lives.

Accordingly, it is an object of the present disclosure to provide an equivalent resistance method to simulate the transient dynamics performance of winding insulation faults with high fidelity, which avoids experimental damage to motors and lays a solid foundation for accurate management of motor driving systems.

Citation or identification of any document in this application is not an admission that such a document is available as prior art to the present disclosure.

### SUMMARY

The above objectives are accomplished according to the present disclosure by providing a fast and high-fidelity insulation fault model for a permanent magnet synchronous motor. The model may include a model permanent magnet synchronous motor, an equivalent resistance simulation to simulate a number of turns of stator windings in the model permanent magnet synchronous motor, at least one feature extraction for motor winding fault diagnosis and prognosis, at least two different sampling frameworks; and at least one module. Further, the model may include at least four modules comprising a stator voltage balancing module, a motion module, an electromagnetic torque module and an inductance generating module. Still, the stator balancing module may be based on equation:

$${U}_{abcs} = {r}_{abcs} {i}_{abcs} + {L}_{abcs} \frac{d}{dt} {i}_{abcs} + \frac{d}{dt} [ {Ψ}_{abcs} ] , \\ [ \begin{matrix}{U}_{as} \\ {U}_{bs} \\ {U}_{cs}\end{matrix} ] = [ \begin{matrix}{r}_{aa} & 0 & 0 \\ 0 & {r}_{bb} & 0 \\ 0 & 0 & {r}_{cc}\end{matrix} ] [ \begin{matrix}{i}_{as} \\ {i}_{bs} \\ {i}_{cs}\end{matrix} ] + [ \begin{matrix}{L}_{aa} & {L}_{ba} & {L}_{ca} \\ {L}_{ab} & {L}_{bb} & {L}_{cb} \\ {L}_{ac} & {L}_{bc} & {L}_{cc}\end{matrix} ] \frac{d}{dt} [ \begin{matrix}{i}_{as} \\ {i}_{bs} \\ {i}_{cs}\end{matrix} ] + \frac{d}{dt} [ \begin{matrix}{ψ}_{as} \\ {ψ}_{bs} \\ {ψ}_{cs}\end{matrix} ] . \qquad ( 1 )$$

Again, the motion module may be based on equation:

Tₑ−T_{L}−Bw=JPw (7).

Further again, the electromagnetic torque module may be based on equation:

$${T}_{e} = \frac{P}{2} \{ \frac{1}{2} {i}_{acss}^{T} \frac{d ( {L}_{abcs} )}{d θ} {i}_{abcs} + {i}_{abcs}^{T} \frac{d ( {ψ}_{m} )}{d θ} \} . \qquad ( 6 )$$

Moreover, the inductance generating module may be based on equation:

$$\{ \begin{matrix}{L}_{aa} = {L}_{ls} + {\ddot{L}}_{m} - {L}_{Δ m} cos ( 2 θ ) \\ {L}_{bb} = {L}_{ls} + {\ddot{L}}_{m} - {L}_{Δ m} cos ( 2 θ + \frac{2 π}{3} ) \\ {L}_{cc} = {L}_{ls} + {\ddot{L}}_{m} - {L}_{Δ m} cos ( 2 θ + \frac{2 π}{3} ) \\ {L}_{ab} = {\ddot{L}}_{m} cos ( \frac{2 π}{3} ) - {L}_{Δ m} cos ( 2 θ + \frac{2 π}{3} ) \\ {L}_{bc} = {\ddot{L}}_{m} cos ( \frac{2 π}{3} ) - {L}_{Δ m} cos ( 2 θ ) \\ {L}_{ac} = {\ddot{L}}_{m} cos ( \frac{2 π}{3} ) - {L}_{Δ m} cos ( 2 θ + \frac{2 π}{3} )\end{matrix} . \qquad ( 2 )$$

Still again, the model may include at least one fault index parameter dependent on at least insulation fault resistance, stator resistance, a number of winding turns of a fault, and/or a total number of turns per winding. Further yet, a fault may injected into the model permanent magnet synchronous motor via replacing at least one permanent magnet synchronous motor parameter with at least one fault index parameter. Still again, the fault may be based on a relationship of the at least one fault index parameter and a number of fault turns, a total number of turns per winding and/or an insulation fault resistance. Again further, the model permanent magnet synchronous motor may have at least one input comprising voltage amplitude or load. Furthermore, the model permanent magnet synchronous motor may have at least one output comprising three-phase stator current, three-phase stator current, three-phase stator voltage, motor torque, back electromotive force, or rotor speed.

In a further embodiment, a method for diagnosis and prognosis of permanent magnet synchronous motors is provided. The model may include forming a permanent magnet synchronous motor model; injecting at least one fault into the permanent magnet synchronous motor model; conducting data analysis; conducting future fault diagnosis; and implementing at least one diagnostic and prognostic algorithm. Further, amplitude and phase asymmetry of the permanent magnet synchronous motor model may reflect non-identical motor parameters containing fault information. Yet again, the method may introduce Hilbert transform to evaluate asymmetries in permanent magnet synchronous motor construction. Further yet, the Hilbert transform may create at least one analytic signal from at least one signal received from the permanent magnet synchronous motor model. Still further, the at least one analytic signal may contain at least an amplitude and phase information of the at least one signal received from the permanent magnet synchronous motor model. Again further, the method may describe variations in winding symmetry via standard deviation of average amplitude of each phase current over a finite time interval to evaluate winding insulation faults in the permanent magnet synchronous motor model. Further again, the at least one diagnostic algorithm and prognostic algorithm may be a EKF for nonlinear system dynamics. Still yet, the method may indicate motor winding fault dynamics with nonlinear systems:

xₖ₊₁=ƒ(xₖ,uₖ)+wₖ (8)

yₖ=h(xₖ,uₖ)+vₖ (9)

Furthermore, the method may implement at least one diagnostic and prognostic algorithm via developing a fault growth model given by:

y(t)=y(t−1)+p₁·(p₂·t+p₃·t⁻²)+w(t) (18)

These and other aspects, objects, features, and advantages of the example embodiments will become apparent to those having ordinary skill in the art upon consideration of the following detailed description of example embodiments.

### BRIEF DESCRIPTION OF THE DRAWINGS

An understanding of the features and advantages of the present disclosure will be obtained by reference to the following detailed description that sets forth illustrative embodiments, in which the principles of the disclosure may be utilized, and the accompanying drawings of which:

FIG. 1 shows a three-phase wye-connected permanent-magnet synchronous motor.

FIG. 2 shows an advanced 3-phase PM machine model.

FIG. 3 shows a schematic of insulation fault model.

FIG. 4 shows Thevenin circuit transformation of the winding fault model.

FIG. 5 shows a modified three-phase wye-connected permanent-magnet synchronous motor.

FIG. 6 shows the packaged 3-phase PM machine model.

FIG. 7 shows simulated three-phase currents with no fault.

FIG. 8 shows Table 1—List of Motor Parameters.

FIG. 9 shows Winding insulation fault index w_{f} curve.

FIG. 10 shows simulated three-phase currents for stator winding insulation fault with fault index wₐ being decreased.

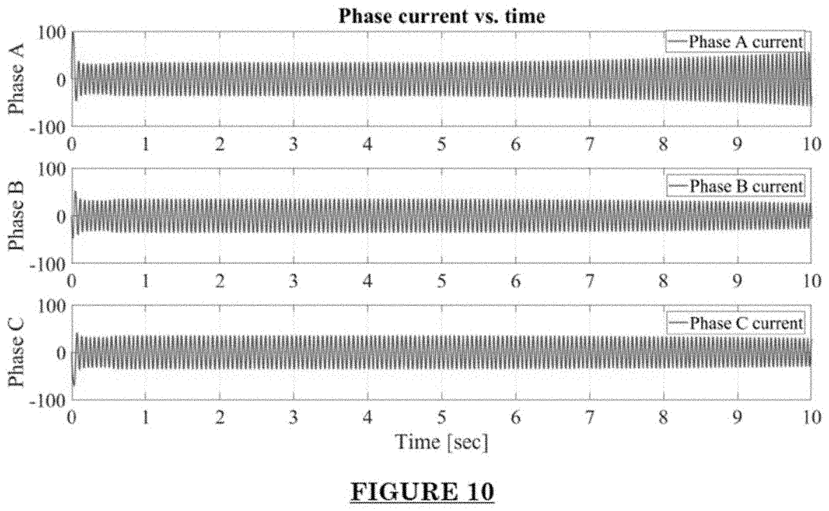

FIG. 11 shows a flow diagram of one embodiment of motor winding insulation diagnosis and prognosis using resistance simulation method under Riemann sampling (RS) and Lebesgue sampling (LS) framework.

FIG. 12 shows a simulated feature curve derived from the three-phase stator currents with no fault.

FIG. 13 shows a simulated feature curve derived from the three-phase stator currents with the winding insulation.

FIG. 14 shows EKF based non-linear estimation.

FIG. 15 shows results of fault diagnosis and prognosis.

FIG. 16 shows Results of probability distribution function of remaining useful life.

FIG. 17 shows α−λ accuracy with the accuracy cone shrinking with the time on RUL vs. time plot.

FIG. 18 shows Alpha-Lambda performance metric using 30% accuracy bounds.

The figures herein are for illustrative purposes only and are not necessarily drawn to scale.

### DETAILED DESCRIPTION OF THE EXAMPLE EMBODIMENTS

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Where a range is expressed, a further embodiment includes from the one particular value and/or to the other particular value. The recitation of numerical ranges by endpoints includes all numbers and fractions subsumed within the respective ranges, as well as the recited endpoints. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the singular forms “a”, “an”, and “the” include both singular and plural referents unless the context clearly dictates otherwise.

As used herein, “about,” “approximately,” “substantially,” and the like, when used in connection with a measurable variable such as a parameter, an amount, a temporal duration, and the like, are meant to encompass variations of and from the specified value including those within experimental error (which can be determined by e.g. given data set, art accepted standard, and/or with e.g. a given confidence interval (e.g. 90%, 95%, or more confidence interval from the mean), such as variations of +/−10% or less, +/−5% or less, +/−1% or less, and +/−0.1% or less of and from the specified value, insofar such variations are appropriate to perform in the disclosure. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “optional” or “optionally” means that the subsequent described event, circumstance or substituent may or may not occur, and that the description includes instances where the event or circumstance occurs and instances where it does not.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment”, “an embodiment,” “an example embodiment,” means that a particular feature, structure or characteristic described in connection with the embodiment is included in at least one embodiment of the present disclosure. Thus, appearances of the phrases “in one embodiment,” “in an embodiment,” or “an example embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the disclosure. For example, in the appended claims, any of the claimed embodiments can be used in any combination.

All patents, patent applications, published applications, and publications, databases, websites and other published materials cited herein are hereby incorporated by reference to the same extent as though each individual publication, published patent document, or patent application was specifically and individually indicated as being incorporated by reference.

### Nomenclature

Ψ_{abcs} Flux linkages
Ψm Max flux linkage
rₐₐ; r_{bb}; r_{cc} Single phase resistance
Lₐₐ; L_{bb}; L_{cc} Self-inductance
L_{ab}; L_{ac}; L_{bc} Mutual inductance
N Number of total winding turns
k Number of winding turns between fault
L_{S} Total winding inductance during normal conditions
Rₛ Winding resistance during normal conditions
Rₛ^{f}, R_{f} Resistance of the insulation fault
Zₜₕ Equivalent Thevenin impedance
Lₛ^{f} Self-inductance of winding with insulation fault
W_{f} Fault index
i_{abcs} Stator current
ωᵣ Motor speed
Tₑ Torque
θ The angle between stator and rotor
Wₘ Energy stored in magnetic ux
U_{oc} Open circuit voltage of fault part
U_{abcs} Output voltage for each winding
Uₒ Voltage of faultless part of the winding
U_{f} Voltage of fault part of the winding

The current disclosure provides for creating a fast and high-fidelity insulation fault model of PMSM and creating a fast and high-fidelity motor model under Simulink environment which can simulate the dynamic performance of a motor accurately. The disclosure uses an equivalent resistance simulation method to simulate the number of short turns of stator winding with the help of an established motor model and the given relationship between the value of the resistance and the number of short turns of stator winding. The Hilbert transform method is used for feature extraction based on experimental three-phase current data. Fault diagnosis and prognosis of the experimental motor is conducted based on existing features under a Riemann/Lebesgue sampling framework.

An equivalent resistance simulation method is used to simulate the dynamic performance of motor winding insulation fault with the help of a high fidelity motor model and experimental data. An effective feature extraction method is introduced for motor winding fault diagnosis and prognosis. The motor fault diagnosis and prognosis is conducted under two different sampling frameworks, which result in low computation and small uncertainty accumulation.

The simulation results show that this novel equivalent resistance diagnosis and prognosis method can simulate the transient dynamic performance of the winding insulation fault with high fidelity, which is better than traditional resistance methods. Compared with the program under Riemann sampling (covered by this disclosure), the program under a Lebesgue sampling framework can greatly improve efficiency, simplify the process, and improve accuracy.

The purpose of building a Permanent Magnet Synchronous Motor (PMSM) model is to enable the winding insulation fault injection in a motor, along with fault (clogging) in a filter, to establish a multi-dimensional environment that can be used in automated contingency management development. This enables one to mature the dynamic simulation-based ACM system for a life support system and integrate diagnosis, prognosis, and optimization into health and contingency management functions to mitigate the fault effects and reduce the risk of NASA system failure or mission failure.

PMSM Modeling

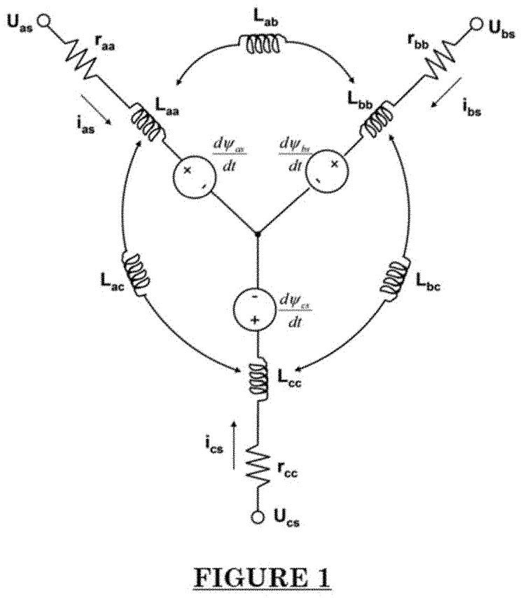

FIG. 1 shows the equivalent circuit diagram of a three-phase wye-connected PMSM [Note: the stator windings are displaced evenly at 120 degrees]. In FIG. 1, Uₐₛ; U_{bs} and U_{cs} are input voltage to phase a, b and c of the motor, Lₐₐ; L_{bb} and L_{cc} are self-inductance of phase a, b and c, rₐₐ; r_{bb} and r_{cc} are resistance of phase a, b and c, L_{ab}; L_{ac} and L_{bc} are mutual inductance between phases, iₐₛ; i_{bs} and i_{cs} are stator current of phase a, b and c, as; Ψ_{bs} and Ψ_{cs} are Ψᵤₓ are flux linkage of phase a, b and c, respectively. FIG. 1 shows a three-phase wye-connected permanent-magnet synchronous motor.

With this equivalent circuit and Kircho's law, a set of differential equations can be obtained as:

$${U}_{abcs} = {r}_{abcs} {i}_{abcs} + {L}_{abcs} \frac{d}{dt} {i}_{abcs} + \frac{d}{dt} [ {Ψ}_{abcs} ] , \\ [ \begin{matrix}{U}_{as} \\ {U}_{bs} \\ {U}_{cs}\end{matrix} ] = [ \begin{matrix}{r}_{aa} & 0 & 0 \\ 0 & {r}_{bb} & 0 \\ 0 & 0 & {r}_{cc}\end{matrix} ] [ \begin{matrix}{i}_{as} \\ {i}_{bs} \\ {i}_{cs}\end{matrix} ] + [ \begin{matrix}{L}_{aa} & {L}_{ba} & {L}_{ca} \\ {L}_{ab} & {L}_{bb} & {L}_{cb} \\ {L}_{ac} & {L}_{bc} & {L}_{cc}\end{matrix} ] \frac{d}{dt} [ \begin{matrix}{i}_{as} \\ {i}_{bs} \\ {i}_{cs}\end{matrix} ] + \frac{d}{dt} [ \begin{matrix}{ψ}_{as} \\ {ψ}_{bs} \\ {ψ}_{cs}\end{matrix} ] . \qquad ( 1 )$$

where L_{ab}=L_{ba}; L_{ac}=L_{ca}; L_{bc}=L_{cb}.

These equations describe the relationships of the stator voltages (Uₐₛ, U_{bs} and U_{cs}) with stator current (iₐₛ, i_{bs} and i_{cs}), flux linkage (Ψₐₛ, Ψ_{bs}, and Ψ_{cs}) and resistance (rₐₐ, r_{bb}, and r_{cc}) for each winding. See, S. E. Lyshevski, V. A. Skormin, and R. D. Colgren, “High-torque density integrated electro-mechanical flight actuators,” IEEE Transactions on Aerospace and Electronic Systems, vol. 38, no. 1, pp. 174{182, 2002.

Note that the stator self-inductances (Lₐₐ, L_{bb}, and L_{cc}) are maximum when the rotor is aligned with each winding accordingly. In contrast, the mutual inductances (L_{ab}, L_{ac}, L_{ba}, L_{bc}, L_{ca}, L_{cb}) are minimum when the rotor is aligned midway between the two corresponding windings accordingly. This behavior is expressed below in Eq. (2) for the self-inductances and the mutual inductances with respect to rotor position θ. The symbols \ddot{L}ₘ, L_{Δm} and Lₗₛ represent the stator magnetization inductances, and leakage inductance,

respectively.

$$\{ \begin{matrix}{L}_{aa} = {L}_{ls} + {\ddot{L}}_{m} - {L}_{Δ m} cos ( 2 θ ) \\ {L}_{bb} = {L}_{ls} + {\ddot{L}}_{m} - {L}_{Δ m} cos ( 2 θ + \frac{2 π}{3} ) \\ {L}_{cc} = {L}_{ls} + {\ddot{L}}_{m} - {L}_{Δ m} cos ( 2 θ + \frac{2 π}{3} ) \\ {L}_{ab} = {\ddot{L}}_{m} cos ( \frac{2 π}{3} ) - {L}_{Δ m} cos ( 2 θ + \frac{2 π}{3} ) \\ {L}_{bc} = {\ddot{L}}_{m} cos ( \frac{2 π}{3} ) - {L}_{Δ m} cos ( 2 θ ) \\ {L}_{ac} = {\ddot{L}}_{m} cos ( \frac{2 π}{3} ) - {L}_{Δ m} cos ( 2 θ + \frac{2 π}{3} )\end{matrix} \qquad ( 2 )$$

Note that the third term in Eq. (1) can be expanded in terms of the winding inductance matrix L_{abc} and magnetic flux linkage vector Ψₘ as D. Brown, G. Georgoulas, H. Bae, G Vachtsevanos, R Chen, Y. Ho, G Tannenbaum, and J. Schroeder, “Particle filter based anomaly detection for aircraft actuator systems,” in 2009 IEEE Aerospace Conference, IEEE, 2009, pp. 1-13:

$${Ψ}_{abcs} = {L}_{abcs} + {Ψ}_{m} , \\ [ \begin{matrix}{ψ}_{as} \\ {ψ}_{bs} \\ {ψ}_{cs}\end{matrix} ] + [ \begin{matrix}{L}_{aa} & 0 & 0 \\ 0 & {L}_{bb} & 0 \\ 0 & 0 & {L}_{cc}\end{matrix} ] [ \begin{matrix}{i}_{as} \\ {i}_{bs} \\ {i}_{cs}\end{matrix} ] + [ \begin{matrix}{ψ}_{am} \\ {ψ}_{bm} \\ {ψ}_{cm}\end{matrix} ] \qquad ( 3 )$$

where Ψₐₛ, Ψ_{bs}, and Ψ_{cs} are magnetic flux linkage of phase a, b and c respectively. Flux linkages at the stator windings due to the permanent magnets on the rotor are given, see D. Brown, G. Georgoulas, H. Bae, G Vachtsevanos, R Chen, Y. Ho, G Tannenbaum, and J. Schroeder, “Particle filter based anomaly detection for aircraft actuator systems,” in 2009 IEEE Aerospace Conference, IEEE, 2009, pp. 1-13:

$${Ψ}_{m} = [ \begin{matrix}{ψ}_{am} \\ {ψ}_{bm} \\ {ψ}_{cm}\end{matrix} ] = {ψ}_{m} [ \begin{matrix}sin ( θ ) \\ sin ( θ - \frac{2 π}{3} ) \\ sin ( θ + \frac{2 π}{3} )\end{matrix} ] \qquad ( 4 )$$

where θ is the angle between the rotor and the stator.

The torque Tₑ can be described by first developing an analytical expression for the energy Wₘ stored in the magnetic flux Ψₘ, given in Eq. (5), in which P is the number of magnetic poles, see S. E. Lyshevski, V. A. Skormin, and R. D. Colgren, “High-torque density integrated electro-mechanical flight actuators,” IEEE Transactions on Aerospace and Electronic Systems, vol. 38, no. 1, pp. 174{182, 2002.

$${W}_{m} = \frac{P}{2} \{ \frac{1}{2} {i}_{abcs}^{T} {L}_{abcs} {i}_{abcs} + {i}_{abcs}^{T} {Ψ}_{m} \} \qquad ( 5 )$$

Then the motor torque is computed by taking the derivative of Wm with respect to the rotor position θ, which leads to torque expression, see S. E. Lyshevski, V. A. Skormin, and R. D. Colgren, “High-torque density integrated electro-mechanical flight actuators,” IEEE Transactions on Aerospace and Electronic Systems, vol. 38, no. 1, pp. 174{182, 2002:

$${T}_{e} = \frac{P}{2} \{ \frac{1}{2} {i}_{acss}^{T} \frac{d ( {L}_{abcs} )}{d θ} {i}_{abcs} + {i}_{abcs}^{T} \frac{d ( {ψ}_{m} )}{d θ} \} \qquad ( 6 )$$

With the torque Tₑ, its relationship with rotor speed w and load T_{L} can be obtained as:

Tₑ−T_{L}−Bw=JPw (7)

where B, J P and w are viscous damping, inertia, pole pairs and rotor speed, respectively.

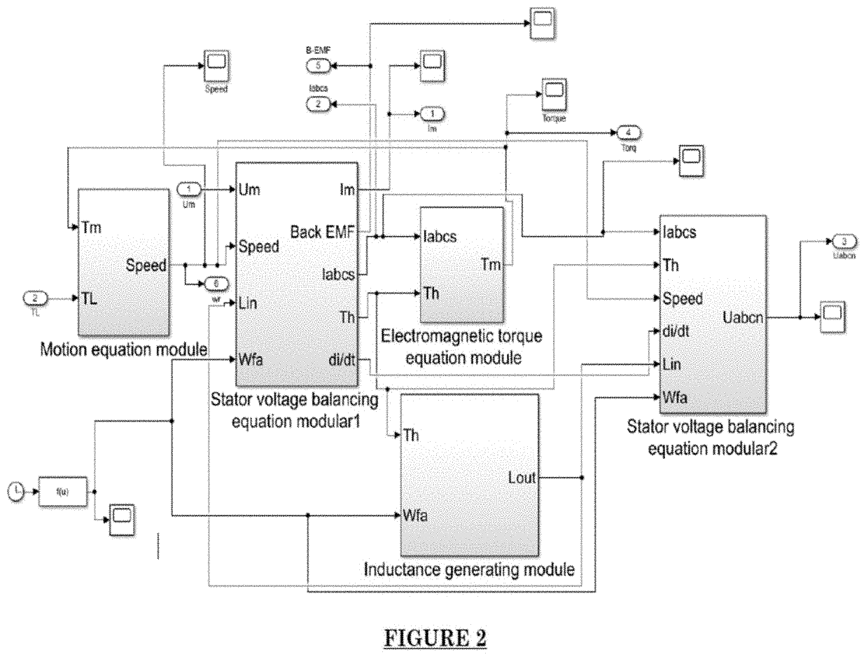

A complete three phase PMSM model is established in Simulink as shown in FIG. 2 based on the physical law and equivalent circuit of the motor analyzed above. The three-phase PMSM model includes four modules of stator voltage balancing module, motion module, electromagnetic torque module and inductance generating module, respectively.

The stator voltage balancing module is built from Eq. (1). The inputs of this module are input voltage U_{abcs}, stator current i_{abcs}, rotor position θ, rotor speed w and stator inductance L_{abcs}. This module describes the relationships of the stator voltage U_{abcs} with stator current i_{abcs}, rotor position θ, rotor speed w and stator inductance L_{abcs} for each winding.

The motion module is built from Eq. (7). This module describes the relationships of output of rotor speed w with the inputs of torque Tₑ and load T_{L}. We can see from Eq. (7) that the rotor speed w is inversely proportional to the load T_{L} when the torque Tₑ is constant.

The inductance generating module is built from Eq. (2). For salient motor, the stator inductance L_{abcs} are closely linked to the rotor position θ due to the salient effect of the motor. Therefore, the inductance generating module needs to modify the stator inductance according to the rotor position based on the relationships of the stator inductance L_{abcs} with rotor position θ given as Eq. (2).

The electromagnetic torque module is built from Eq. (6). This module describes the relationships of torque Tₑ with the input of stator current i_{abcs} generated from the stator voltage balancing module and stator inductance L_{abcs} generated from the inductance generating module.

Stator Winding Insulation Fault Injection

The primary failure type for the PMSM is stator winding insulation fault (turn-to-turn winding fault). A stator winding insulation fault can result in three-phase impedance imbalance in the stator windings, which will lead to asymmetries in the phase currents, phase voltage, increased harmonic generation, torque fluctuation, and other performance degradations, see X. Chang, V. Cocquempot, and C. Christophe, “A model of asynchronous machines for stator fault detection and isolation,” IEEE Transactions on Industrial Electronics, vol. 50, no. 3, pp. 578{584, 2003, and J Penman, H. Sedding, B. Lloyd, and W. Fink, “Detection And Location Of Interturn Short Circuits In The Stator Windings Of Operating Motors,” IEEE transactions on Energy Conversion, vol. 9, no. 4, pp. 652{658, 1994. In this disclosure, we only focus on a single stator winding insulation fault for PMSM.

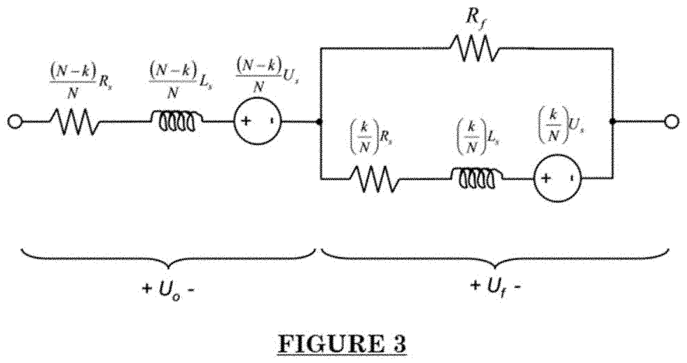

FIG. 3 shows a schematic that represents a winding insulation fault for a single winding, in which Lₛ; Rₛ and Uₛ represent the total winding inductance, resistance and back-emf voltage of the winding, N; k and R_{f} represent the number of total winding turns, number of winding turns of the fault, and the resistance of the insulation fault, respectively. Note that k=0 indicates a normal condition.

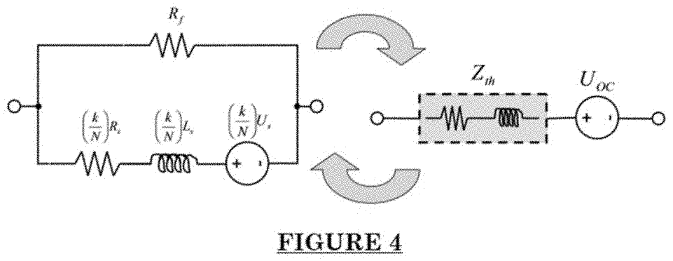

The circuit network on the right side of FIG. 3 can be reduced to a single resistor, inductor and voltage source, as illustrated below in FIG. 4, by applying the Thevenin circuit transformation where Zₜₕ is Thevenin impedance and U_{OC} is open circuit voltage. FIG. 3 shows a schematic of insulation fault model. FIG. 4 shows a Thevenin circuit transformation of the winding fault model.

With some mathematical operations, simplified expressions for Rₛ^{f}, Lₛ^{f}, and ψₛ^{f} can be obtained in terms of Ls, Rs, Ψₛ and w_{f} given as:

[Rₛ^{f}(t)Lₛ^{f}(t)ψₛ^{f}(t)]^{T}≈w_{f}(t)[RₛLₛψₛ]^{T} (8)

where w_{f} is the fault index, which is inversely proportional to the dimension of the stator winding insulation fault and is expressed as:

$${w}_{f} ( {R}_{f} , {R}_{s} , k , N ) = 1 - \frac{k}{N} ( 1 - {[ 1 + \frac{k}{N} ( \frac{{R}_{s}}{{R}_{f}} ) ]}^{2} ) \qquad ( 9 )$$

where 0≤w_{f}≤1.

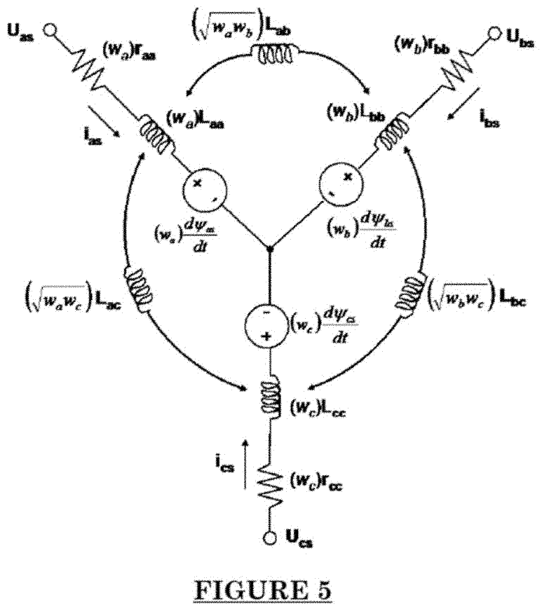

It shows that the fault index wf depends on the insulation fault resistance R_{f}; stator resistance Rₛ; number of winding turns of the fault k; and total number of turns per winding N. Define the fault indexes for three phases (a, b and c) as wₐ, wb and w_{c}. When the stator winding insulation faults are injected, the relevant parameters of the PMSM need to be modified by the fault indexes w_{f}. By replacing each winding parameter with its equivalent fault parameters according to Eqs. (8) and (9), a modified three-phase wye-connected electrical diagram shown below in FIG. 5) is obtained. The fault can be injected to the motor stator according to the relationships of the fault-parameters with the number of fault turns k, total number of turns per winding N and the insulation fault resistance R_{f}. From FIG. 5), we can see that the related parameters should be modified by fault index W_{f} which is closely linked to the number of winding turns of the fault k given in Eq. (9). FIG. 5 shows a modified three-phase wye-connected permanent-magnet synchronous motor.

Model Simulation

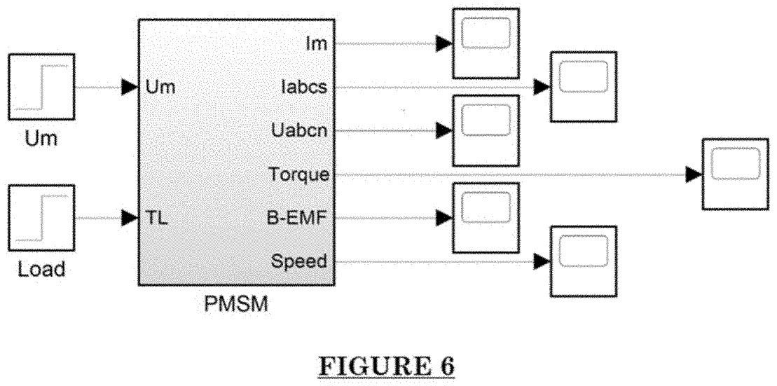

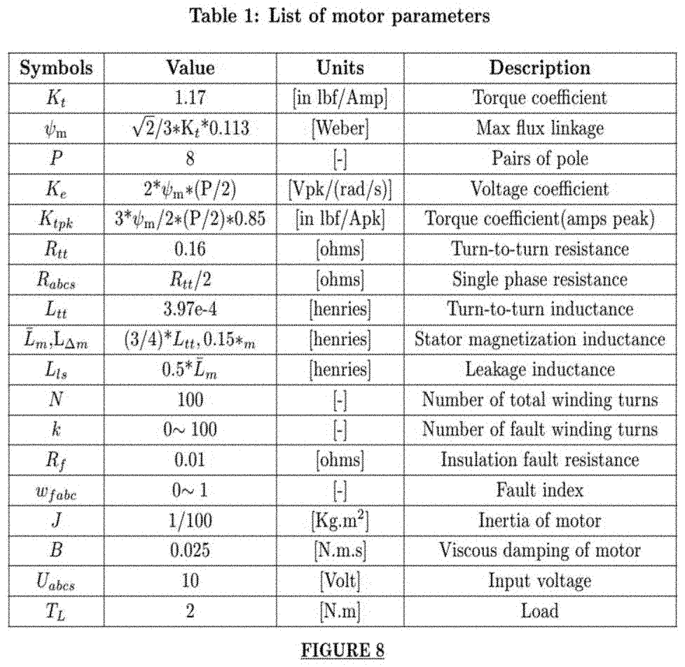

By combining the four motor modules, a packaged 3-phase PMSM model is established as FIG. 6. FIG. 6 shows that the PMSM model has two inputs and six outputs. The inputs Um and TL are input voltage amplitude and Load, respectively. The outputs Iₘ, I_{abcs}, U_{abcn}, Torque, B-EMF, Speed are sum of the three-phase stator currents, three-phase stator currents, three-phase stator voltage, motor torque, back electromotive force, rotor speed, respectively. We can adjust the input values and parameters of the motor according to real motor parameters on its nameplate to simulate the corresponding motor under test. In this project, the PMSM model is evaluated by a motor with the main default simulation parameters given in Table 1, see FIG. 8.

The PMSM model is operated with and without winding insulation fault injection respectively. The three-phase currents of the motor are used as examples and are compared to analyze the behavior of the motor. FIG. 6 shows the packaged 3-phase PM machine model.

Simulation of Healthy Motor

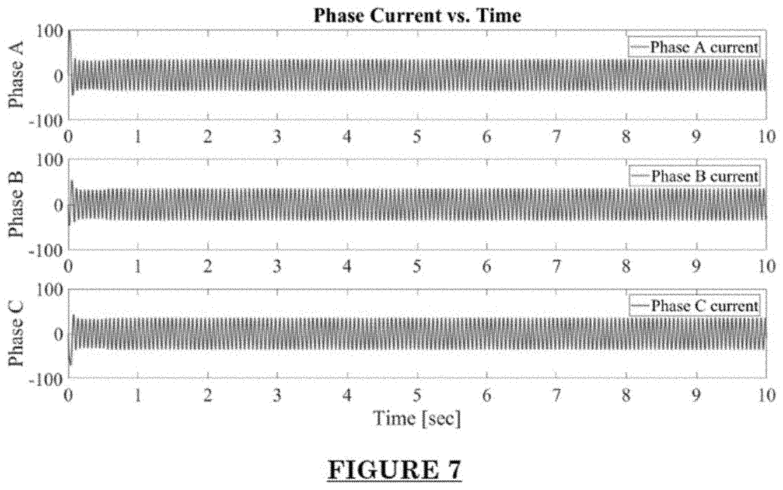

The simulated three-phase currents in healthy condition without faults being injected are shown in FIG. 7. FIG. 7 shows simulated three-phase currents with no fault. FIG. 7 shows that the three-phase currents (i_{abcs}) spike when the motor starts up. This is caused by the step input voltage (U_{abcs}) at the beginning. Since the parameters of the motor for each winding are equal to each other, and the electrical physical layout and three-phase input voltage are symmetrical, the three-phase currents are symmetrical to each other when the motor runs in steady state. That means the amplitudes of the three-phase currents are equal to each other and the phase difference between phase-currents is 120 degrees when the rotor runs in steady state with no fault injection.

Simulation of Motor with Fault

The modified three-phase wye-connected PMSM with winding insulation fault injection shown in FIG. 5, the degree of stator winding insulation fault can be indicated by the value of fault index W_{f}. The number of winding fault turns (k) can be adjusted from the range of 0 to N, which lead to the fault index wf changes from 1 to 0 according to Eq. (9). A stator winding insulation fault is injected to phase A at the 5th second and continuously simulated with phase A winding fault index w_{fa} decreasing from 1 to 0.7 (the number of fault turns k increasing from 0 to 32 non-linearly). The dynamic insulation fault injection process of stator of phase A is shown as FIG. 8. FIG. 8 shows winding insulation fault index wf curve.

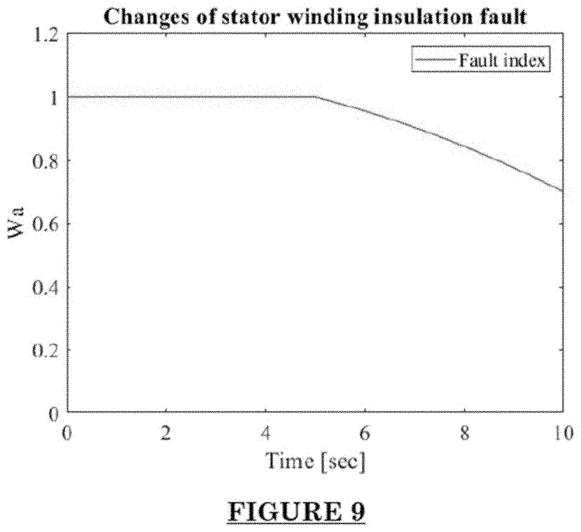

FIG. 9 shows the simulation results with insulation fault injection on phase A winding. FIG. 9 shows that the phase currents become asymmetric under fault conditions. The phase A current amplitude increases from 20 A to 50 A and the phase B and phase C current amplitude decreases from 20 A to 10 A as an increasing number of fault winding turns is injected to phase A stator. The amplitudes of the three-phase currents become no longer equal to each other and the difference between current-phase varies from phase to phase.

The reason is that the fault injection on phase A results in non-identical motor parameters of each winding, which eventually leads to asymmetric three-phase currents shown in FIG. 9. FIG. 9 shows simulated three-phase currents for stator winding insulation fault with fault index wa being decreased. Besides, with increase of number of fault winding turns, the value of phase A stator impedance reduces, which in turn increases the amplitude of phase A stator current and decreases the amplitude of phase B and phase C current if the input voltage keeps unchanged. Above analysis shows that the asymmetric three-phase currents contain valuable winding insulation fault information. We can take advantage of the asymmetric three-phase currents information to extract health index of the motor to enable data analysis and diagnosis for the motor.

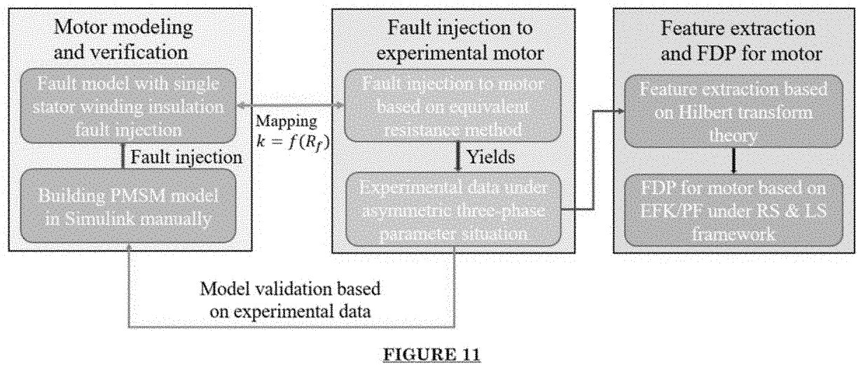

FIG. 11 shows a flow diagram of one embodiment of motor winding insulation diagnosis and prognosis using resistance simulation method under Riemann sampling (RS) and Lebesgue sampling (LS) framework.

Diagnosis and Prognosis for Permanent Magnet Synchronous Motor

The last section built a PMSM model based on the physical law and the equivalent circuit of the motor. The winding insulation fault was then injected to the PMSM model to enable the data analysis and future fault diagnosis. This section aims to present diagnostics and prognostics theory and simulation of motor stator winding insulation faults. In this scheme, the diagnostic feature was extracted using Hilbert transforms theory based on simulation data acquired from the established PMSM model with different severity levels of the stator winding insulation fault. Diagnostic and prognostic algorithms were developed in the Bayesian estimation framework with an Extended Kalman Filter (EKF). Real-time diagnosis and prognosis of PMSM stator winding insulation faults were performed in Simulink. Simulation results demonstrated the effectiveness of the proposed method.

Feature Extraction

The PMSM Simulink model is able to simulate winding insulation fault of motor continuously with different fault levels by changing the number of insulation fault turns. Simulation results in the previous section showed that faults can lead to asymmetry of amplitudes and phases in the three-phase stator currents. It also showed that the asymmetry of the three-phase currents increases proportional to the winding insulation fault severity levels (given by number of turns of short). In other words, this amplitude and phase asymmetry reflects the non-identical motor parameters of each winding, which contains valuable fault information of the motor. Feature of the motor needs to be extracted from motor simulation data, asymmetric current signals in this research, to detect and isolate winding insulation faults. Aligning with this idea, this section developed a motor health feature extraction method from the three-phase stator current iᵢₛ(t) in the steady state. Here, the subscript index i refers to the phase current of the ith phase stator winding and s indicates steady state. In this method, Hilbert transform was introduced to evaluate the asymmetries caused by winding insulation faults.

Hilbert Transform is a convolution between the Hilbert transformer 1=(πt) and an original phase current signal iᵢₛ(t). This operation results in phase shifting of π=2 radians to the original phase current signal iᵢₛ(t).

The Hilbert transform îᵢₛ(t) of original signal iᵢₛ(t) is defined for all t, see P. Henrici, Applied and computational complex analysis, Volume 3: Discrete Fourier analysis, Cauchy integrals, construction of conformal maps, univalent functions. John Wiley & Sons, 1993, vol. 3.,

$${\hat{i}}_{is} ( t ) = \frac{1}{π} P {\int }_{- ∞}^{∞} \frac{{i}_{is} ( τ )}{t - τ} d τ \qquad ( 1 )$$

The Hilbert transform can be used to create an analytic signal z(t) from a real signal iᵢₛ(t) as follows,

z(t)=iᵢₛ(t)+jîᵢₛ(t) (2)

The signal z(t) can be described as a rotating vector,

Z(t)=A(t)eⁱ^{ᵢₛ}^{φ(t)} (3)

where A(t) is the amplitude and) is the phase, which are given as,

A(t)=\sqrt{iᵢₛ²(t)+iᵢₛ²(t)},

φ(t)=arctan[îᵢₛ(t)/iᵢₛ(t)] (4)

Then for a real signal iᵢₛ(t)=A₀ cos (ω₀t+φ₀), its Hilbert transform is given as:

îᵢₛ=A₀ sin(ω₀t+φ₀) (5)

From Eqs. (2) and (5), it is clear that the amplitude of the analytical signal z(t), denoted by A(t), is a constant and is phase invariant i.e.,

A(t)=A₀ (6)

By introducing the Hilbert transform, an analytic signal z(t) of the original sinusoidal signal iᵢₛ(t) can be obtained from Eq. (2). This analytical signal contains the amplitude and phase information of the original signal iᵢₛ(t). Eqs. (2), (5) and (6) show that the analytic signal z(t) has constant amplitude and frequency if the original signal is ideal sinusoidal. This result can be extended to time-varying three phase current signals to extract the feature for fault detection.

The analysis of motor current signal in the last section showed that for a motor working with no fault, the three-phase stator currents of the motor are symmetrical to each other when the motor runs in steady state. This indicates that the amplitude of the three-phase stator currents is equal to each other and the phase difference between phase-currents is 120 degrees. In this case, the amplitude of the analytic signal |iᵢₛ(t)+îᵢₛ(t)| is phase-invariant. On the contrary, for a motor with fault, the amplitude of the analytic signal |iᵢₛ(t)+îᵢₛ(t)| changes with the severity of motor winding fault. Therefore, the sator winding insulation fault of motor can be evaluated by investigating the change of |iᵢₛ(t)+îᵢₛ(t)|.

In this project, the standard deviation of the average amplitude of each phase current (A, B, C) over a finite time interval T, denoted as iₚ(t, T), was used to describe the variations in winding symmetry, see D. Brown, G. Georgoulas, H. Bae, G Vachtsevanos, R Chen, Y. Ho, G Tannenbaum, and J. Schroeder, “Particle filter based anomaly detection for aircraft actuator systems,” in 2009 IEEE Aerospace Conference, IEEE, 2009, pp. 1-13.

$${i}_{p} ( t , T ) = {std}_{i ∈ \{ A , B , C \}} [ {avg}_{t ∈ ( 0 , T )} \vert {i}_{is} ( t ) + {\hat{i}}_{is} ( t ) \vert ] \qquad ( 7 )$$

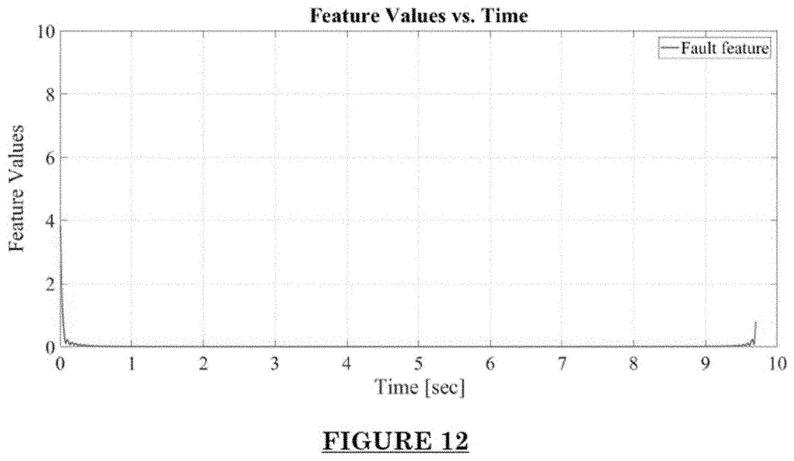

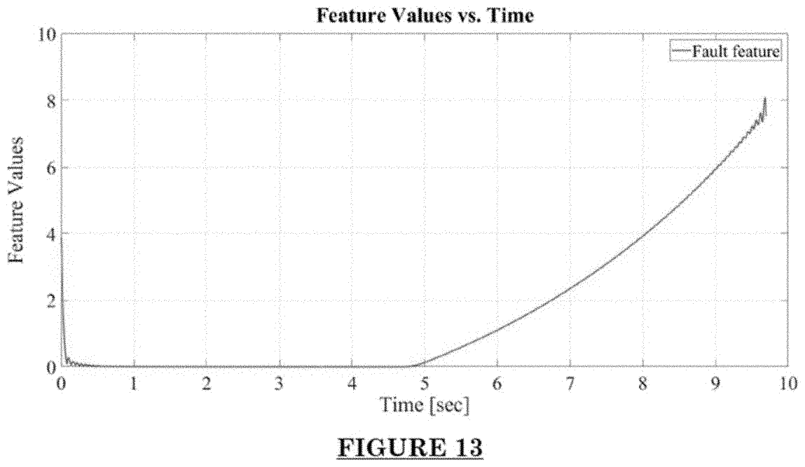

With the above analysis, feature iₚ(t, T) can be extracted to evaluate the condition of winding insulation faults based on Eq. (7). The larger the value of iₚ(t, T), the greater the asymmetry of the three-phase currents and, therefore, the severer the winding fault. The simulation time of the PMSM model was set to 10 seconds to accelerate the growth rate of the stator winding insulation fault. FIG. 12 shows the feature curve for fault-free case and FIG. 13 shows the feature curve with the stator winding insulation fault being injected from the 5th second to the 9th second.

FIGS. 12 and 13 show that the feature curves have spikes (large feature value) at the beginning. This is caused by the asymmetric three-phase currents at the start of the motor and can be eliminated if the feature is extracted only when the motor runs in steady state. It is clear from FIG. 12 that the feature value is constant for motor running in steady state, which indicates that the three-phase stator currents and motor parameters are symmetric in the motor operation without fault being injected. In this case, the conclusion from investigating the feature curve is that the motor is working under “healthy” condition. FIG. 13 shows that, with an increasing winding insulation fault index wf being injected to the stator of phase A at the 5th second, the feature value increases exponentially from the 5th second to the 9th second. The winding insulation fault injection to the stator of phase A results in asymmetric parameters and electrical layout of the motor. This eventually leads to asymmetric three-phase stator currents that result in the increasing value of analytic signal z(t) of the three-phase stator currents. The results show that the feature extracted from the analytic signal z(t) is a good feature of the motor winding insulation fault that can be used for the motor winding insulation fault diagnosis and prognosis.

Fault Detection and Prognosis

Kalman filtering is a recursive algorithm that estimates the true state of a system based on noisy measurements. Kalman Filter (KF) has been used in many applications involving navigation, see Y. Geng and J. Wang, “Adaptive Estimation Of Multiple Fading Factors In Kalman Filter For Navigation Applications,” GPS Solutions, vol. 12, no. 4, pp. 273{279, 2008., online system identification, see M. Wu and A. W. Smyth, “Application Of The Unscented Kalman Filter For Real-Time Nonlinear Structural System Identification,” Structural Control and Health Monitoring: The Official Journal of the International Association for Structural Control and Monitoring and of the European Association for the Control of Structures, vol. 14, no. 7, pp. 971-990, 2007., tracking and fault prognosis T. Mizumoto, T. Takahashi, T. Ogata, and H. G. Okuno, “Adaptive Pitch Control For Robot Thereminist Using Unscented Kalman Lter,” in Modern Advances in Intelligent Systems and Tools, Springer, 2012, pp. 19-24. EKF is an extension of KF for nonlinear system dynamics. In this project, EKF is selected as diagnostic and prognostic algorithm for motor winding since the non-linearity of the motor degradation model is not very strong. The process of the EKF algorithm can be divided into two steps, prediction and update. In EKF, the system model is linearized around the current state to obtain the Jacobians. The linearized model is then used in the prediction step to obtain a priori state estimate. When the measurement becomes available, the a prior state estimate is corrected in the update step to obtain a posterior estimation.

The implementation of EKF requires a Markov model describing the fault dynamics. Mathematically, the model that describes the motor winding fault dynamics can be described by the following nonlinear systems:

xₖ₊₁=f(xₖ,uₖ)+wₖ (8)

yₖ=h(xₖ,uₖ)+vₖ (9)

where Eq. (8) describes the state winding insulation fault transition, and Eq. (9) is the observation model that describes the relationship of state with measurements (feature iₚ(t, T)) extracted from three-phase currents. In Eqs. (8) and (9), wₖ and vₖ are noise terms that are assumed to be Gaussian noise, with zero mean and known covariance matrices Q and R respectively.

Since the motor winding insulation degradation is a non-linear process, the Jacobian of the non-linear

functions ƒ(.) and h(.), denoted as Fₖ and Hₖ, respectively, are calculated at each time instant as:

$$\begin{matrix}{{F}_{k} = \frac{\partial f ( {x}_{k} , {u}_{k} )}{\partial {x}_{k}} \vert}_{{x}_{k} = {\hat{x}}_{k + 1 \vert k}} & ( 10 ) \\ {{H}_{k} = \frac{\partial h ( {x}_{k} , {u}_{k} )}{\partial {x}_{k}} \vert}_{{x}_{k} = {\hat{x}}_{k + 1 \vert k}} & ( 11 )\end{matrix}$$

The prediction step is to calculate a prior estimate as follows:

\hat{x}_{k+1|k}=ƒ(\hat{x}_{k|k},uₖ)+wₖ (12)

P_{k+1|k}=FₖP_{k|k}Fₖ^{T}+Qₖ (13)

The Kalman gain is calculated as:

Kₖ₊₁=P_{k+1|k}Hₖ₊₁^{T}(Hₖ₊₁Pₖ₊₁ₖHₖ₊₁^{T}+Rₖ₊₁)⁻¹ (14)

When new measurement (feature) becomes available, the a priori state estimate is updated as:

\hat{x}_{k+1|k+1}=\hat{x}_{k+1|k}+Kₖ₊₁zₖ₊₁ (15)

where zₖ₊₁ is the measurement residual, which is given by

zₖ₊₁=yₖ₊₁−h(\hat{x}_{k+1|k},uₖ) (16)

The last step is to update the covariance estimate,

P_{k+1|k+1}=(I−Kₖ₊₁Hₖ₊₁)P_{k+1|k} (17)

To implement diagnosis and prognosis based on EKF method, the features extracted from the asymmetric three-phase currents shown in FIG. 13 are used to develop the fault growth model, which is given by:

y(t)=y(t−1)+p₁·(p₂·t+p₃·t⁻²)+w(t) (18)

where t is time index, p=[3:2e. 5; 8; 1e. 3] are parameters, ω(t)˜N(0, 0.02) is the model noise.

Experimental Results Using Simulation Data

In this experiment, the motor was set to run from 0 to 10 seconds. The winding insulation fault was injected at the 5th second and continue increases to the 9th second non-linearly as shown in the previous section. For diagnosis and prognosis, some parameters need to be set first. In the simulation, the sampling rate was set to 10000 Hz and a moving window of 3000 sample signal points was used to calculate the feature. The moving window shifts at a step of 200 signal points to reduce the size of feature data. With the given sampling rate and feature extraction window, 30 feature values were extracted from the current data in 0.6 seconds before the fault injection and these feature values were used as the baseline data to build a baseline distribution. The failure threshold was set to 7, which corresponds to 28 turns of winding insulation fault. This failure threshold was chosen because, at this level of fault, the amplitude of phase (A, B, C) currents changed from 20 A to (45, 13, 13) A, respectively. The significant change indicates that the asymmetry of three-phase currents and electrical layout of the motor were serve and the motor must be stopped to avoid damage to the motor.

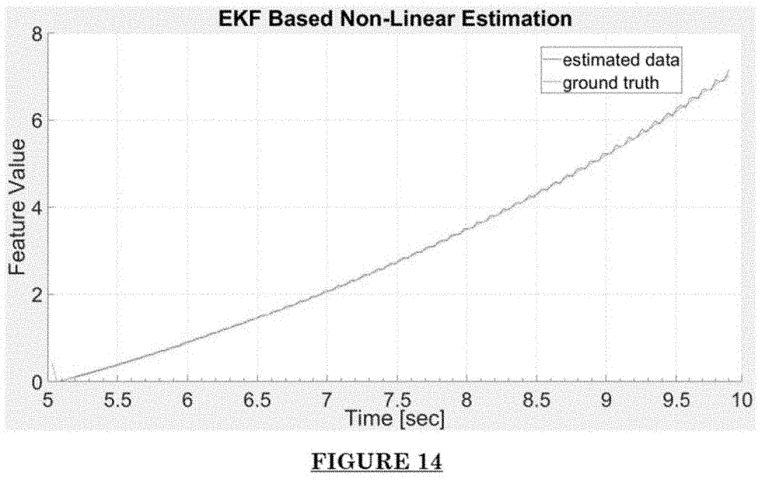

FIG. 14 shows the non-linear estimation of mean value based on EKF. Gaussian noise with variance of 0.02 was added to the winding insulation degradation process model. FIG. 14 shows that the fault injected at the 5th second was detected at the 6th second. In other words, the fault was detected after 18 feature values were taken by the diagnostic algorithm. When the fault was detected, the fault index wf=0.95, which corresponds to winding insulation fault increases from 0 turns to 6 turns. At this moment, the three phase currents of (A, B, C) changed to (24, 19, 19) A, respectively. The result shows that the proposed method is able to detect fault winding fault accurately with high sensitivity. Moreover, the figure shows that the estimated data (red line) follows the ground truth data (blue line) very well, which indicates that the fault model given in Eq. (18) is sufficient to describe the winding fault insulation degradation dynamics.

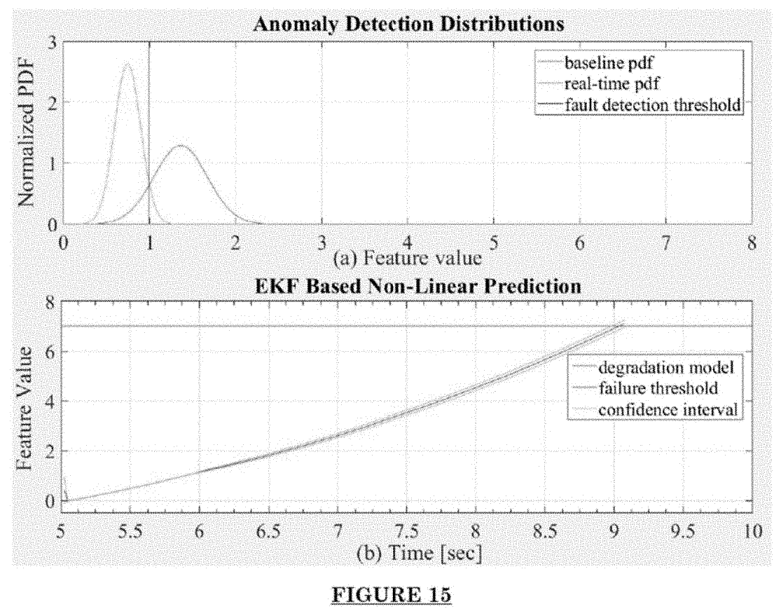

FIG. 14 only shows the mean of diagnosis for fault from the beginning to the end of motor life. To further investigate the performance of fault diagnosis, the fault state estimation pdf is studied and the results are shown in FIG. 15 at (a). As mentioned earlier, in fault diagnosis, data from the first 0.75 seconds before the fault injection was used to build the baseline distribution probability density function (pdf). The baseline distribution (given in green) is shown in FIG. 15 at (a). The baseline distribution has a mean of 0.7437 and variance of 0.1516. In this project, false alarm and confidence of detection were defined as 5% and 90%, respectively. With a 5% fault alarm, the fault detection threshold can be obtained from the baseline distribution and it is given as 1, shown in blue line. Then, the EKF diagnostic algorithm was implemented in real time when a feature value (extracted from the asymmetric three-phase current in the moving window with a size of 300 samples) become available. The outcome from the EKF diagnostic algorithm is the real-time fault state pdf (given in red), which is compared with the baseline distribution for fault diagnosis.

Since the confidence of detection is defined as 90%, when 90% of the real time fault state pdf deviates from the baseline pdf and moves to the right side of the fault detection threshold, the algorithm claims the fault was detected. In this experiment, the fault was detected at the 6th second.

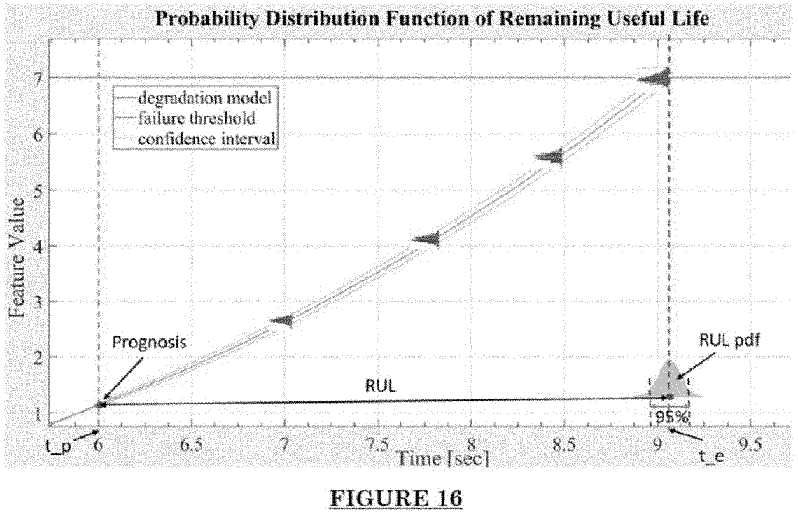

In fault prognosis process, since the measurement in future time instants are not available, there is only prediction step but no update step. Then, the estimated mean and covariance of the fault state are only updated from previous values according to Eqs. (12) and (13). In this process, the posterior fault state distribution from diagnosis was used as the initial condition of prognosis. FIG. 15 at (b) shows that the prognosis began at the 6th second when the fault was detected. FIG. 16 shows the results of probability distribution function of remaining useful life of the motor. The figure shows the mean value and 95% confidence interval of the predicted state distribution. With the fault state pdf at all future time instants, the RUL distribution can be obtained by comparing these state pdf against the failure threshold. The RUL is calculated as RUL=tₑ−tₚ and is shown in FIG. 16. Here, tₑ and tₚ are the mean of the estimated RUL distribution and starting point of the prediction, respectively. Since EKF is used, the RUL distribution from EKF-based prognosis at the 6th second is a Gaussian distribution with mean value of 3.08 seconds when the mean predicted fault state reaches the failure threshold. Compared with the ground truth RUL, which is 3 seconds (prediction starting time is at the 6th second and the failure time is the 9th second), the predicted RUL of 3.08 seconds is accurate.

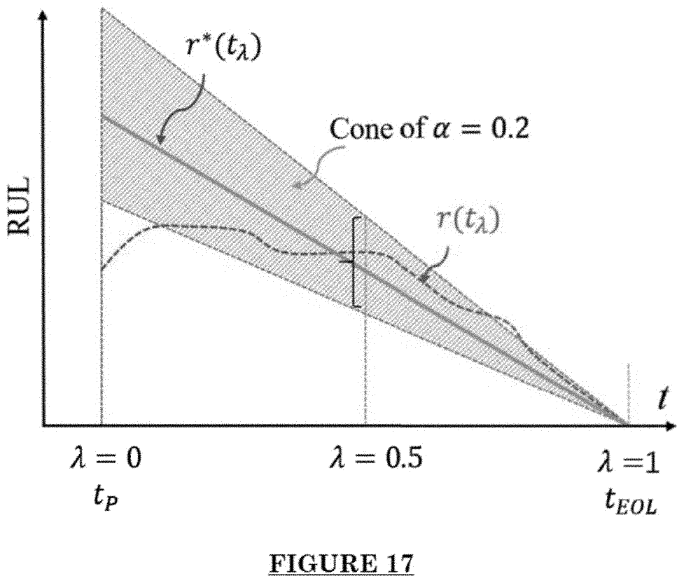

To evaluate the overall accuracy of prognosis, α−λ metric was used, which measures whether the predictions of RUL fall into an accuracy zone, defied by the shaded cone zone given in FIG. 17 A. Saxena, J. Celaya, B. Saha, S. Saha, and K. Goebel, “Metrics For Offline Evaluation Of Prognostic Performance,” International Journal Of Prognostics And Health Management, Vol. 1, no. 1, pp. 4-23, 2010. In this figure, the shaded cone zone is defined by 100% of the ground truth RUL at all the time instants. For a given time instant t_{λ}, with λ varies from 0 to 1, this metrics determines whether the prediction at this time instant (a fraction of the entire prediction horizon defined by λ) fall with the accuracy zone (an accuracy defined by and ground truth RUL). Mathematically, it is defined as follows:

[1−α]·r*(t_{λ})≤r(t_{λ})≤[1+a]·r*(t_{λ}) (19)

where a defines the shaded accuracy zone around the ground truth RUL, defies the time span t_{λ}=t_{P}+λ(t_{EOL}−t_{P}) with t_{P} and t_{EOL} being the starting and ending time instants of prediction, r*(t_{λ}) and r(t_{λ}) are the ground truth RUL and the predicted RUL, respectively.

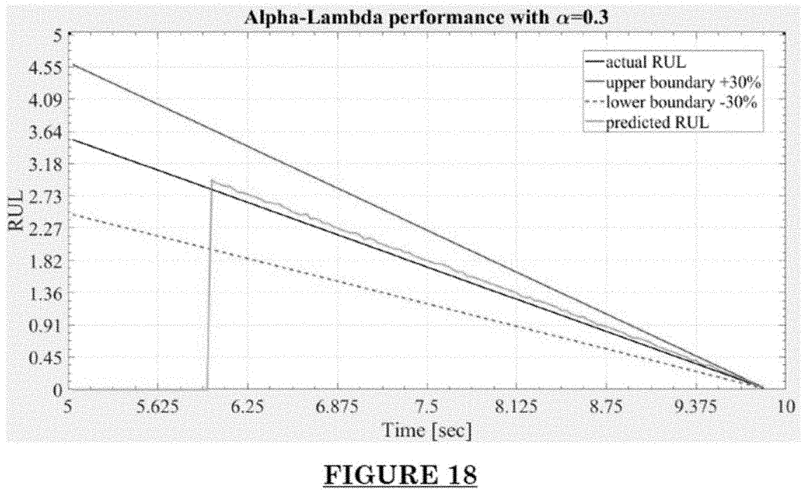

FIG. 18 shows the α−λ metric with simulated data to evaluate the performance of prognosis. It can be observed from FIG. 18 that the prognostic algorithm performs well as its accuracy improved quickly with time within the 30% bounds.

The experimental results in this section showed that the feature extracted from the asymmetric three-phase currents is able to indicate the motor winding fault. With the feature describing the winding degradation, a fault dynamic model was established. Then an extended Kalman filter was designed for fault diagnosis and prognosis. Experimental results on simulation data demonstrated the effectiveness of the developed method.

Various modifications and variations of the described methods, pharmaceutical compositions, and kits of the disclosure will be apparent to those skilled in the art without departing from the scope and spirit of the disclosure. Although the disclosure has been described in connection with specific embodiments, it will be understood that it is capable of further modifications and that the disclosure as claimed should not be unduly limited to such specific embodiments. Indeed, various modifications of the described modes for carrying out the disclosure that are obvious to those skilled in the art are intended to be within the scope of the disclosure. This application is intended to cover any variations, uses, or adaptations of the disclosure following, in general, the principles of the disclosure and including such departures from the present disclosure come within known customary practice within the art to which the disclosure pertains and may be applied to the essential features herein before set forth.

What is claimed is:

1. A fast and high-fidelity insulation fault model for a permanent magnet synchronous motor comprising:
a model permanent magnet synchronous motor;
an equivalent resistance simulation to simulate a number of turns of stator windings in the model permanent magnet synchronous motor;
at least one feature extraction for motor winding fault diagnosis and prognosis;
at least two different sampling frameworks; and
at least one module.

2. The model of claim 1, further comprising at least four modules comprising a stator voltage balancing module, a motion module, an electromagnetic torque module and an inductance generating module.

3. The model of claim 2, wherein the stator balancing module is based on equation:
$${U}_{abcs} = {r}_{abcs} {i}_{abcs} + {L}_{abcs} \frac{d}{dt} {i}_{abcs} + \frac{d}{dt} [ {Ψ}_{abcs} ] , \\ [ \begin{matrix}{U}_{as} \\ {U}_{bs} \\ {U}_{cs}\end{matrix} ] = [ \begin{matrix}{r}_{aa} & 0 & 0 \\ 0 & {r}_{bb} & 0 \\ 0 & 0 & {r}_{cc}\end{matrix} ] [ \begin{matrix}{i}_{as} \\ {i}_{bs} \\ {i}_{cs}\end{matrix} ] + [ \begin{matrix}{L}_{aa} & {L}_{ba} & {L}_{ca} \\ {L}_{ab} & {L}_{bb} & {L}_{cb} \\ {L}_{ac} & {L}_{bc} & {L}_{cc}\end{matrix} ] \frac{d}{dt} [ \begin{matrix}{i}_{as} \\ {i}_{bs} \\ {i}_{cs}\end{matrix} ] + \frac{d}{dt} [ \begin{matrix}{ψ}_{as} \\ {ψ}_{bs} \\ {ψ}_{cs}\end{matrix} ] . \qquad ( 1 )$$

4. The model of claim 2, wherein the motion module is based on equation:
Tₑ−T_{L}−Bw=JPw (7).

5. The model of claim 2, wherein the electromagnetic torque module is based on equation:
$${T}_{e} = \frac{P}{2} \{ \frac{1}{2} {i}_{acss}^{T} \frac{d ( {L}_{abcs} )}{d θ} {i}_{abcs} + {i}_{abcs}^{T} \frac{d ( {ψ}_{m} )}{d θ} \} . \qquad ( 6 )$$

6. The model of claim 2, wherein the inductance generating module is based on equation:
$$\{ \begin{matrix}{L}_{aa} = {L}_{ls} + {\ddot{L}}_{m} - {L}_{Δ m} cos ( 2 θ ) \\ {L}_{bb} = {L}_{ls} + {\ddot{L}}_{m} - {L}_{Δ m} cos ( 2 θ + \frac{2 π}{3} ) \\ {L}_{cc} = {L}_{ls} + {\ddot{L}}_{m} - {L}_{Δ m} cos ( 2 θ + \frac{2 π}{3} ) \\ {L}_{ab} = {\ddot{L}}_{m} cos ( \frac{2 π}{3} ) - {L}_{Δ m} cos ( 2 θ + \frac{2 π}{3} ) \\ {L}_{bc} = {\ddot{L}}_{m} cos ( \frac{2 π}{3} ) - {L}_{Δ m} cos ( 2 θ ) \\ {L}_{ac} = {\ddot{L}}_{m} cos ( \frac{2 π}{3} ) - {L}_{Δ m} cos ( 2 θ + \frac{2 π}{3} )\end{matrix} . \qquad ( 2 )$$

7. The model of claim 1, further comprising at least one fault index parameter dependent on at least insulation fault resistance, stator resistance, a number of winding turns of a fault, and/or a total number of turns per winding.

8. The model of claim 7 wherein a fault is injected into the model permanent magnet synchronous motor via replacing at least one permanent magnet synchronous motor parameter with at least one fault index parameter.

9. The model of claim 8, wherein the fault is based on a relationship of the at least one fault index parameter and a number of fault turns, a total number of turns per winding and/or an insulation fault resistance.

10. The model of claim 1, wherein the model permanent magnet synchronous motor has at least one input comprising voltage amplitude or load.

11. The model of claim 1, wherein the model permanent magnet synchronous motor has at least one output comprising three-phase stator current, three-phase stator current, three-phase stator voltage, motor torque, back electromotive force, or rotor speed.

12. A method for diagnosis and prognosis of permanent magnet synchronous motors comprising:
forming a permanent magnet synchronous motor model;
injecting at least one fault into the permanent magnet synchronous motor model;
conducting data analysis;
conducting future fault diagnosis; and
implementing at least one diagnostic and prognostic algorithm.

13. The method of claim 12, wherein amplitude and phase asymmetry of the permanent magnet synchronous motor model reflect non-identical motor parameters containing fault information.

14. The method of claim 12, comprising introducing Hilbert transform to evaluate asymmetries in permanent magnet synchronous motor construction.

15. The method of claim 14, wherein Hilbert transform creates at least one analytic signal from at least one signal received from the permanent magnet synchronous motor model.

16. The method of claim 15, wherein the at least one analytic signal contains at least an amplitude and phase information of the at least one signal received from the permanent magnet synchronous motor model.

17. The method of claim 12, further comprising describing variations in winding symmetry via standard deviation of average amplitude of each phase current over a finite time interval to evaluate winding insulation faults in the permanent magnet synchronous motor model.

18. The method of claim 12, wherein the at least one diagnostic algorithm and prognostic algorithm is an EKF for nonlinear system dynamics.

19. The method of claim 12, further comprising indicating motor winding fault dynamics with nonlinear systems:
xₖ₊₁=ƒ(xₖ,uₖ)+wₖ (8)
yₖ=h(xₖ,uₖ)+vₖ (9).

20. The method of claim 12, further comprising implementing at least one diagnostic and prognostic algorithm via developing a fault growth model given by:
y(t)=y(t−1)+p₁·(p₂·t+p₃·t⁻²)+w(t) (18).
